(19) United States
(12) Patent Application Publication
(10) Pub. No.: US 2011/0071890 A1
(43) Pub. Date: Mar. 24, 2011

(54) System and method for bundled selling of goods and services at a prepaid fixed price using the internet

(76) Inventors: Ryan Andrew Hart, Puyallup, WA (US); Amad Almsaodi, University Place, WA (US); Kyle Moses Hart, Puyallup, WA (US)

(21) Appl. No.: 12/586,454

(22) Filed: Sep. 21, 2009

(51) Int. Cl. G06Q 30/00

(52) U.S. Cl. 705/14.16; 705/26.35

(57) ABSTRACT

A system and method for bundled selling of goods or service at a prepaid fixed price to a plurality of individual buyers in one transaction by an aggregation of demand using the Internet. A seller communicates with a controller and a conditional sales offer is broadcast for a minimum quantity of a product or service at a fixed price within a defined time period. The broadcast offer is received by a plurality of individual buyers who collectively communicate a willingness to purchase at the fixed price by accepting the offer and making a form of monetary payment. The buyers are encouraged to promote the product to friends to meet the required order quantity and reduce marketing costs for the seller. Preferably no user accounts, no user registration, and no Shopping Carts are employed so as to avoid registration abandonment and Shopping Cart abandonment.

### BACKGROUND OF THE INVENTION

1. Field of the Invention

The present invention relates to electronic commerce utilizing the Internet and, more particularly, to a system and method for marketing products and services utilizing the Internet.

2. Background of the Related Art

The World Wide Web has provided a convenient mechanism for marketing products. Many websites offer products for sale. Generally a potential customer viewing such a website indicates a desire to purchase a particular product by “clicking” on a particular location on the display screen, such as clicking on a link to place an item in a Shopping Cart. Some sites require a user to “register” by giving a name, address, and credit card information. Later, when a customer desires to buy a product, information entered during registration is used for billing and shipping. Other sites allow a customer to enter billing and shipping information after the customer has indicated the desire to purchase a particular product.

Some websites allow a buyer to bid on products that are offered in the website's equivalent of an auction. Other websites allow a user to made an offer to buy products at a price specified by the buyer, much as an individual might make an offer to buy a product at a particular price in a face-to-face situation.

In essence, the websites described above utilize the Internet to automate a conventional buying process. The process takes place at great speed and the parties may be remote, but the fundamental transaction is conventional.

Firms face many problems when conducting business in e-commerce including abandonment issues, pricing issues, and quantity issues.

Required registration and the use of Shopping Carts are the two top website abandonment issues and translate to a significant number of lost sales. New users exit websites when required to register with no feedback to the website. See, for example, Forrester Research, “Improve Online Check-Out Functionality”, Marta Baigorri et al., Dec. 22, 2008, “Forcing users to register before they make a purchase is an unnecessary roadblock that can actually deter them from wanting to give you money.”, and Forrester Research, “Required Registration Lowers Online Conversion Rates”, Megan Burns et al., Apr. 15, 2008, “Twenty-three percent of survey respondents said that they abandoned the site without completing the required registration process.” Similarly, websites using Shopping Carts experience abandoned Shopping Carts for no apparent reason and with no feedback to the website. According to a Stanford University article, between 60-65% of Internet shoppers abandon the items they place in their shopping cart (see http://cse.stanford.edu/class/cs201/projects-99-00/software-patents/amazon.html).

Manufacturers with established brand names seek to maintain brand equity and perception by establishing and requiring retailers to use a minimum advertised price. Thus, many Internet retailers are not allowed to sell below the manufacturer's minimum advertised price.

Many Internet retailers spend larger amounts of money directing traffic to their websites and marketing their selection and items online. Despite website traffic, however, many items do not sell because there is no sense of urgency established in the mind of the purchaser to buy the product. Further, when an item is purchased on conventional websites, there is no incentive for the purchaser to share the knowledge of their purchase with anyone else.

Manufacturers, distributors, and retail outlets including Internet outlets have excess inventory of many products. For example, many products are most cost effectively produced in large batches or quantities. Brands have a need to promote new items. Many products are seasonal and do not sell out by the end of the season so that out of season items are left in inventory to be sold the next year. Many retailers have overstocked items due to variable demand.

Internet sales are a loss center for many companies because quantities of one are shipped. For example, many companies lose money paying for labor involved in shipping only one item at a time.

Prior art on-line marketing systems and methods include U.S. Pat. No. 6,269,343 to Matthew G. Pallakoff in which sellers communicate conditional offers to potential buyers using demand-based pricing, i.e., pricing based on quantity ordered according to a price/volume graph, so that until the total quantity ordered within the designated time frame is known, buyers may not know exactly what price they will have to pay and may be reluctant to register for this reason. Similar “demand aggregation” on-line systems and methods using demand-based pricing have been disclosed by Tom Van Horn et al. in U.S. Pat. Nos. 6,604,089; 6,631,356; and 6,934,690. In U.S. Pat. No. 6,934,690, for example, Shopping Carts may be employed. Such prior art on-line systems and methods may experience failure of buyers to go forward with a purchase, i.e., failure to make payment, if the price increases due to a small demand and/or if they have lost interest or purchased a competitor's product or service at another website.

It is therefore an object of the invention to provide a new paradigm for marketing and selling goods and services using the Internet. The present invention is a system and method that utilizes the Internet to aggregate potentially unrelated buyers into a buying group to collectively purchase “a bundle”, i.e., “a minimum lot of goods or services”, at a fixed price, paid in advance, within a set period of time, with no registration and no Shopping Cart required.

### SUMMARY OF THE INVENTION

The present invention accomplishes this and other objects by providing a system for bundled selling of goods and services to a plurality of buyers at a prepaid fixed price within a defined time period using the internet, comprising a system controller which includes a computer means; a seller's communication device that communicates with the system controller so that a seller can transmit to the system controller a conditional sales offer for a product or service that specifies a fixed price per unit conditioned upon at least a minimum quantity of units being ordered within a defined time period after which the conditional sales offer expires; broadcast means for broadcasting the conditional sales offer in communication with the system controller; and at least one buyer's communication device that communicates with the system controller so that the plurality of buyers respectively transmit to the system controller (a) an acceptance of the conditional sales offer for the sale of the product and (b) make payment of the fixed price via a payment processor, and so that the system controller either (a) executes the sale when at least the minimum quantity of units are ordered within the determined time period or (b) cancels the conditional sales offer and reverses the payment of the fixed price to each of the plurality of individual buyers.

The seller communication device may be one of (a) a computer terminal so that the seller communicates with the system controller via the Internet, (b) a hard-wired telephone, (c) a mobile telephone, (d) a PDA, (e) an Information Appliance, and (f) a related electronic communication device.

The broadcast means for broadcasting the conditional sales offer for the plurality of buyers to hear or view may include at least one of (a) an Internet website in communication with the system controller that includes a web page that displays the conditional sales offer, (b) a radio, (c) a hard-wired telephone, (d) a mobile telephone, (e) a PDA, (f) an Information Appliance, (g) a television, (h) a web TV, (i) an interactive TV, and (j) a related hearing or viewing device.

When the broadcast means is at least one Internet website through which the plurality of buyers communicates with the system controller via the Internet, preferably the at least one Internet website does not require respective buyers to register any information as a prerequisite to viewing the web page that displays the conditional sales offer. Moreover, the Internet website preferably employs a payment processor but does not include any form of Internet Shopping Cart.

The at least one buyer communication device may include one or more of (a) a computer terminal which communicates with the system controller either directly or over the Internet via an Internet website or (b) a communication means for communicating with the system controller including one of (1) a hard-wired telephone, (2) a mobile telephone, (3) a PDA, (4) an Information Appliance, (5) a web TV, (6) an interactive TV, and (7) a related communication device.

The seller may offer an additional or unlimited quantity of units at the fixed price per unit within the defined time period so long as at least the minimum quantity of units is ordered within the defined time period.

The present invention additionally accomplishes this and other objects by providing a method for bundled selling of goods and services to a plurality of buyers at a prepaid fixed price within a defined time period using the Internet, the method comprising the steps of: (a) receiving at a system controller that includes a computer means a conditional sales offer from a seller via a seller's communication device, the conditional sales offer offering a product or service at a fixed price per unit conditioned upon at least a minimum quantity of units being ordered within a defined time period after which the conditional sales offer expires; (b) broadcasting the conditional sales offer to the plurality of individual buyers via broadcasting means which is in communication with the system controller; (c) receiving, via at least one buyer's communication device that communicates with the system controller, transmissions from respective ones of the plurality of buyers indicating (1) an acceptance of the conditional sales offer for the sale of the product and (2) making payment of the fixed price via a payment processor so that the system controller either (1) executes the sale when at least the minimum quantity of units are ordered within the determined time period or (2) cancels the conditional sales offer and reverses the payment of the fixed price to each of the plurality of buyers; and (d) communicating to the plurality of buyers and the seller either (1) that the system controller has executed the sale because at least the minimum quantity of units have been ordered within the determined time period or (2) that the system controller has canceled the conditional sales offer and reversed the payment of the fixed price to each of the plurality of buyers.

In the method, the seller's communication device may be one of (a) a computer terminal so that the seller communicates with the system controller via the Internet, (b) a hard-wired telephone, (c) a mobile telephone, (d) a PDA, (e) an Information Appliance, and (f) a related electronic communication device.

The broadcast means for broadcasting the conditional sales offer for the plurality of buyers to hear or view may include at least one of (a) an Internet website in communication with the system controller that includes a web page that displays the conditional sales offer, (b) a radio, (c) a hard-wired telephone, (d) a mobile telephone, (e) a PDA, (f) an Information Appliance, (g) a television, (h) a web TV, (i) an interactive TV, and (j) a related hearing or viewing device.

When the broadcast means is at least one Internet website through which the plurality of buyers communicates with the system controller via the Internet, preferably the at least one Internet website does not require respective individual buyers to register any information as a prerequisite to viewing the web page that displays the conditional sales offer. Moreover, the Internet website preferably employs a payment processor but does not include any form of Internet Shopping Cart.

The at least one buyer communication device includes one or more of (a) a computer terminal which communicates with the system controller either directly or over the Internet via an Internet website or (b) a communication means for communicating with the system controller including one of (1) a hard-wired telephone, (2) a mobile telephone, (3) a PDA, (4) an Information Appliance, (5) a web TV, (6) an interactive TV, and (7) a related communication device.

The method permits the seller to offer an additional or unlimited quantity of units at the fixed price per unit within the defined time period so long as at least the minimum quantity of units is ordered within the defined time period.

The method preferably includes a system operator that provides the system controller for communicating conditional sales offers from the seller to the plurality of buyers. Then, the system operator receives a commission on the fixed price paid by the plurality of buyers to the seller. The conditional sales offer may be broadcast by being displayed on at least one website operated by a respective website operator, and the system operator and each respective website operator receive a commission on the fixed price paid by the plurality of buyers to the seller.

The payment processor may function in the method to collect a credit card number, obtain a pre-authorization of the payment from respective credit card issuers, and either (a) process the payment directly or (b) hold the processing in abeyance for a brief period. In the case of the latter, credit card issuers permit manual processing of a payment by the payment processor for as long as about 7 days after pre-authorization is given. Then, payment is manually processed when the sale is executed or the payment is reversed by not manually processing the payment when the sale is cancelled. Thus, “reverse the payment” as used herein is intended to include (a) refunding a charge payment if directly processed in advance of execution of the sale, which generally results in fee(s) due and paid by the system, and (b) simply reversing the pre-authorized payments held in abeyance within the system by non-action so that fee(s) are reduced to, for example, a pre-authorization fee. The system may elect to use a third party payment processor, such as GOOGLE CHECKOUT.

The method may advantageously further comprise requesting that respective buyers promote the product or service to others within their respective social networks to facilitate reaching the minimum quantity of units.

The system controller may advantageously execute the sale by placing one simultaneous order with at least one of the seller and a supplier so that a cost effective simultaneous shipment to respective buyers takes place. Such “light bulk” shipping facilitates warehouse access of stored goods.

The system and method of the present invention facilitate the aggregation of demand for the purchase of a product or service by a plurality of individual buyers. The transaction is conditioned upon reaching the required minimum quantity of units within the defined time period. Abandoned orders are prevented by a payment processor obtaining a form of monetary payment, a prepayment, in advance. Individual buyers are encouraged to promote the product or service within their social networks for the purpose of meeting the required minimum quantity of units within the defined time period and may be contacted periodically such as by email within the defined time period.

By deliberately eliminating user registration/user accounts, and Shopping Carts, the present invention has eliminated the top two abandonment issues involved in the purchasing process. Brand equity and perception is maintained by selling items contingent on a minimum order quantity and within a specified and limited timeframe so that the present invention removes the two main reasons why manufacturing/brands establish and maintain a minimum advertised price for retailers. By offering the items contingent on selling out within the specified and limited timeframe, a sense of urgency is established, as well as an incentive to share the product offering with acquaintances of the buyers by word of mouth, e-mail, text messages, AIM, social book marking, and social networking sites such as FACEBOOK, and even with persons unknown such as blog readers, etc. This social type of marketing reduces the need to spend money to advertise the items for sale. Many manufacturers and distributors have overstocked, out of season, over produced, items available for preorder or promotional items waiting to be sold. The present invention provides a market to sell such items in a manner which produces a higher selling price and expedited cash flow than traditional liquidation methods. Finally, economies of scale are established to package and ship the items all at one time by providing suppliers with a bulk order of the specific item which facilitates efficiency of ware housing. In these ways, the present invention solves many of the issues encountered by the prior art.

### BRIEF DESCRIPTION OF THE DRAWING

While the specification concludes with claims particularly pointing out and distinctly claiming the subject matter which is regarded as the invention, it is believed that the invention, the objects and features of the invention and further objects, features and advantages thereof will be better understood from the following description taken in connection with the accompanying drawing figures in which:

FIG. 1 is an overall diagram of the system for bundled selling of goods and services according to the invention in which the communication devices used by the seller and the plurality of buyers are exemplified by computer terminals interconnected via a system controller over the Internet;

FIG. 2 is a high level flow diagram of the various operations that take place in the method of the present invention; and

FIG. 3 is illustrates elements of a web page embodiment in which a conditional sales offer is broadcast, product information is presented, and a third party payment processor is employed, see “GOOGLE CHECKOUT”.

### DETAILED DESCRIPTION OF THE INVENTION

As used herein, the following terms are intended to encompass the meanings given in the following. “Bundle” means a minimum lot of products or services (goods) for sale under the terms of a conditional sale offer. “Defined time period” means the amount of time during which the Bundle is offered for sale. “Deal goes live” means the Bundle is offered for sale and the defined time period has begun. “Share the deal” means the process of forwarding the information regarding the item for sale to another person (via email or other electronic message), posting the information to another web page or blog, or physically communicating the offer to an acquaintance. “Required order quantity” means a minimum quantity of units that must be ordered for the Bundle to be sold. “System Operator” means an individual, company, party, entrepreneur or other entity that operates or is responsible for operating the system controller which is a computer means such as a computer or web server that performs various calculations and operations hereinafter described.

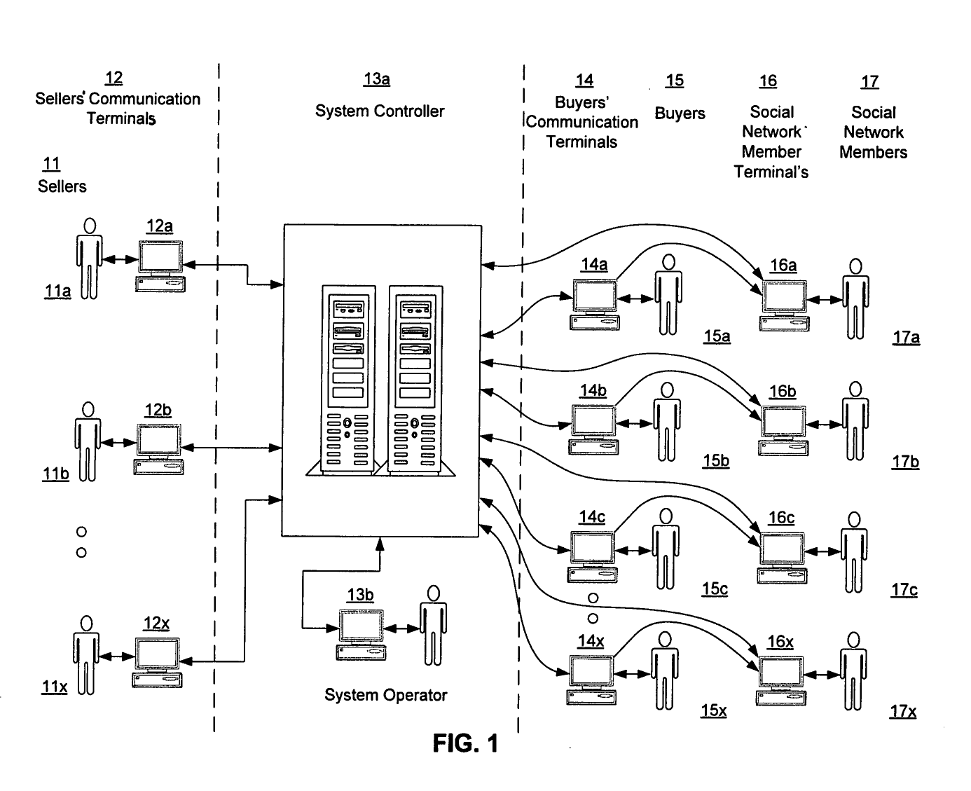

FIG. 1 illustrates an overall diagram of the system for bundled selling of goods and services according to the invention in which the communication devices used by the seller and the plurality of buyers are exemplified by computer terminals interconnected via a system controller over the Internet. The system connects sellers 11 with buyers 15 and potential buyers in the form of social network members 17 by means of a system controller 13. The sellers are designated 11a, 11b, . . . , 11x and are collectively referred to as sellers 11. The buyers are designated 15a, 15b, 15c, . . . , 15x and are collectively referred to as buyers 15. The social network members are designated 17a, 17b, 17c, . . . , 17 x and are collectively referred to as social network members 17. There can be many sellers and buyers; however, the actual number of sellers and buyers is not relevant so long as there is at least one seller and at least one buyer.

As illustrated, sellers 11 communicate with the system controller 13 via seller communication devices 12 exemplified as seller communication terminals or computer terminals 12 (individually designated 12a to 12x) and the buyers 15 communicate with the system controller 13 via buyer communication devices 14 exemplified as buyer communication terminals or computer terminals 14 (individually designated 14a to 14x). The buyers 15 communicate with the social network members' respective communication devices 16 exemplified as social network member terminals or computer terminals 16 (individually designated 16a to 16x) via the buyers communication devices 14, i.e., buyer communication terminals or computer terminals 14. The social network members' 17 communicate with the system controller 13 via social network members' communication devices 16 exemplified as social network members' communication terminals or computer terminals 16. Typically, but not necessarily, communication is via the Internet. As is conventional, terminals 12, 14, and 16 are connected to an ISP (Internet Service Provider) which provides access to the Internet. Likewise system controller 13 is connected to the Internet via an ISP. The lines in FIG. 1 therefore represent logical information flow and not physical connections. The sellers 11, buyers 14, and social network members 16 can be describes as being online.

While FIG. 1 exemplifies computer terminals, the invention contemplates use of any communication means, particularly electronic communication means. Thus, illustration of computer terminals is not intended to limit the scope of the communication devices that may be variously employed. The sellers' communication devices 12 may be terminals 11 and can be any of the various types of terminals that are available such as computers, laptops, thin-clients, WebTVs, Interactive TVs, PDAs, Information Appliances, Mobile Phones, Telephones, or any other device that can be used by sellers to access the system controller 13 over a network, so a seller can specify a conditional sale offer of products or services.

The system controller 13 is a computer means and may be a standalone computer with a single hard drive, but more preferably is one or more conventional networks of servers running software to keep track of sellers' offers (including optional conditions); broadcast, i.e., make offers known to potential buyers including “intelligently” controlling the appearance of the offers on one or more physical or “virtual” media (e.g., websites, television, smart phone applications, etc.); and appropriately track and/or process purchase requests by the buyers who may see and respond to those offers.

A system operator 13b is exemplified as utilizes a conventional computer terminal to access and configure the system controller 13 as is conventional with computer systems and network servers. While FIG. 1 exemplifies system operator 13b as utilizing a computer terminal, the invention contemplates use of any communication means, particularly electronic communication means. Thus, illustration of a computer terminal is not intended to limit the scope of the communication device that may be variously employed by the system operator 13b.

The buyers' communication devices 14 may be any of the various conventional devices that are used to access websites such as computers, laptops, thin-clients, WebTVs, Interactive TVs, PDAs, Information Appliances, Mobile Phones, hard-wired telephones, or any other device that buyers can use to view or hear offers presented by system controller 13 via broadcast means. Buyers can also respond using the same or another buyers' communication device 14. For example, a buyer may view a conditional sale offer on a conventional TV or hear a conditional sales offer on a radio and respond to accept the offer by telephone, via an Avata, or online interface with the system controller. Similarly, the social network members' communication devices 16 may be any of the various conventional devices that are used to access websites as exemplified above. Appropriate interface devices are provided as needed.

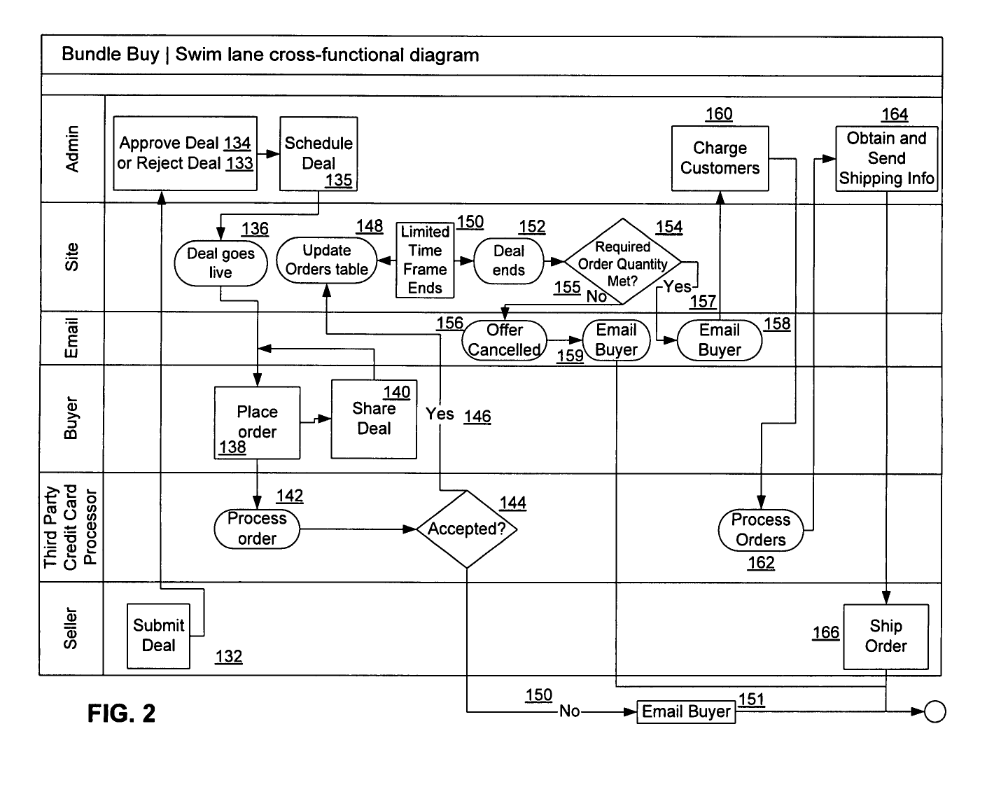

FIG. 2 is a high level overall flow diagram of the various operations that take place in the method of the present invention. The process begins with a seller making an offer to sell a minimum number of units of a particular product or service at a specified fixed price and within a defined, limited time period, see Submit Deal 132. The Bundle Buy administrator, see “Admin”, elects to either accept the seller's Bundle, see Approve Deal 134, or reject the deal and renegotiate the terms, see Reject Deal 133. If the Bundle is accepted, it is scheduled to be broadcast such as by publication on a website, see Schedule Deal 135, and the deal goes live as scheduled, see Deal goes live 136.

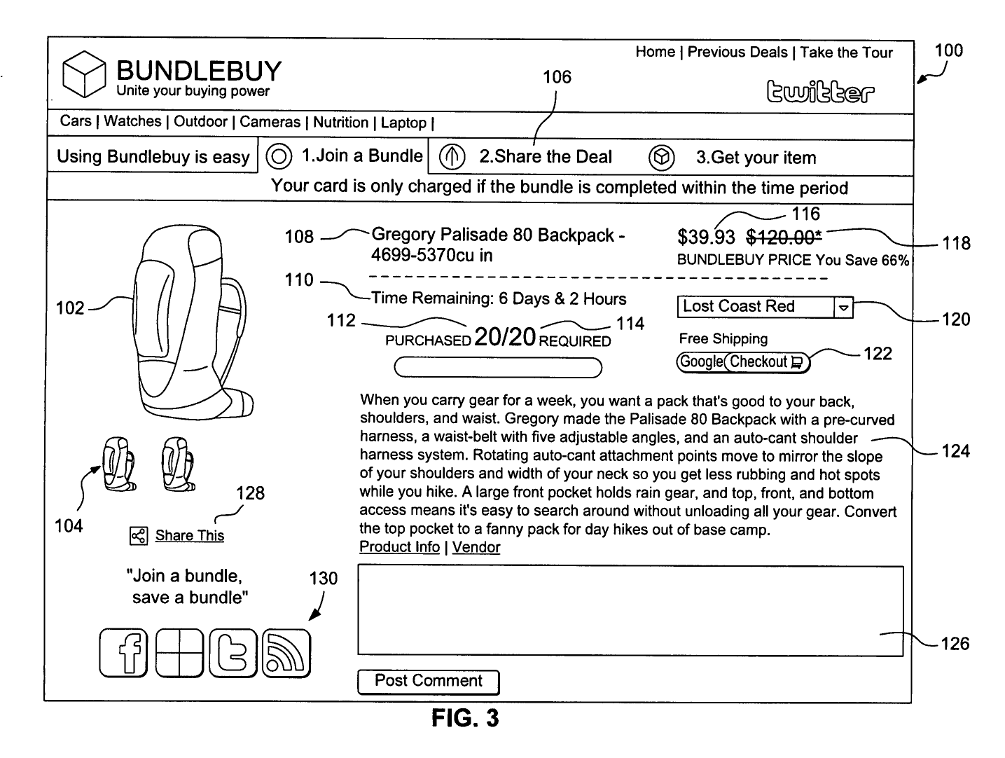

If the limited time period has not yet expired, see Limited Time Frame Ends 150, the system continues to broadcast the offer, such as by displaying the offer on one or more websites. Broadcast of the offer is not limited to being displayed on one or more websites, however, and any of the broadcast means previously described may be employed. In this example, the display will appear on a web page and will have design elements and information as exemplified in FIG. 3. A buyer who sees the offer on a website can then indicate a desire to join the Bundle and place an order, see Place Order 138 by clicking a purchase button illustrated in FIG. 3. At this point, the system's payment processor, which may be a third party payment processor such as GOOGLE CHECKOUT, will obtain billing and shipping information from the buyer (unless it was previously provided during a registration process) and the buyer must indicate the amount of product desired.

The buyer can share the deal, see Share Deal 140, using the third party links (shown in FIG. 3, see 106, 128 and 130) either before or after purchase of the item, see Place Order 138. Furthermore, no purchase is necessary to share the deal, see Share Deal 140.

When the buyer clicks on Placer Order 138, the system's payment processor, which may be a third party payment processor such as GOOGLE CHECKOUT, performs a credit card authentication (pre-authorization) to validate availability of the funds on the credit card, see Process Order 142. If the funds are validated, see Accepted? 144, then the order is entered, see Yes 146, and the order table is updated with the new quantity ordered, see Updated Orders Table 148. If the funds are not validated, then the buyer's order is rejected, see No 150, and the buyer is notified via email, see Email Buyer 151.

The updated quantity ordered, see Update Orders Table 148, at the end of the limited time period, see Limited Time Frame Ends 150 and Deal Ends 152, determines if the Bundle will be sold, see Yes 157, or not, see No 155. When the Deal Ends 152, if the required order quantity, see Required Order Quantity Met? 154, has been reached, then the customer is notified of the sale via email, see Email Buyer 158, the buyers' charge cards, which have been pre-authorized are manually processed 160, the order is processed, see Process Orders 162, the buyer contact and shipping information is obtained, such as from a third party payment processor, for example, GOOGLE CHECKOUT, and forwarded to the seller, see Obtain and Send Shipping Info 164, and the order is shipped, see Ship Order 166.

In the case where the thing being purchased is a service or coupon/voucher for a service, rather than a product, the seller would perform the purchased service for the buyer.

If the required order quantity, see Required Order Quantity Met? 154 and see No 155, has not been reached within the limited time period, see Limited Time Frame Ends 150, then the offer, see Deal Ends 152, and the orders are canceled, see Offer Cancelled 156. When this occurs, the system stops presenting the offer. The system can display a message on the websites indicating that the offer has been cancelled. The seller is notified that the offer has been canceled 161 (not shown) because of insufficient demand. Finally, potential buyers who expressed interest in joining the Bundle for the offer are notified via email 159 (not shown) that the offer has been cancelled because of insufficient demand in a similar manner as the buyers are emailed, see Email Buyer 158.

FIG. 3 illustrates elements of a web page embodiment in which a conditional sales offer is broadcast, product information is presented, and a third party payment processor is employed, see “GOOGLE CHECKOUT”. It is noted that FIG. 3 merely illustrates the fields that are relevant to a preferred embodiment of the invention. FIG. 3 is not meant to illustrate the actual layout of a web page. An actual web page would be laid out in a creative, artistic fashion so as to present a pleasing visual appearance. The artistic nature of the visual appearance of the web page is not relevant to the present invention.

In FIG. 3, a web page 100 includes various fields and/or elements as follows by way of example but not limitation. A field including a conventional heading with logo may be included to identify who is sponsoring the webpage. While not necessary for the operation of the system and method, such a conventional heading is often helpful. A field 108 is shown which describes the name of the product being offered for sale. A field 116 is shown which lists the price of the product. A field 112 is shown which indicates the number of items individual purchasers have, thus far indicated a commitment to buy. A field 114 is shown which indicates the required number of items to be purchased to complete the bundle. A filed 110 is shown which indicated the limited time frame in which the buying process will terminate. A button 122 is shown which a user can “click” to indicate a desire to join the buying process. An image 102 is shown which represents the description of the product for sale 108. Subsequent images 104 are shown which also represent the description of the product for sale 108. A button 128 is shown which allows buyers to access multiple third party providers to share the description 108, image 102, price 116 and quantity purchased 112 and remaining 114 of the product. Buttons 130 are shown which allow buyers to access third party providers to share the description 108, image 102, price 116 and quantity purchased 112 and remaining 114 of the product. A field 126 is shown which a user can submit a comment on the item. A field 124 is shown which describes in detail the product being offered for sale. A button 106 is shown which indicates the steps of the buying process.

Web page 100 as described above relates to selling a single product. It should be noted that a single web page could offer multiple products. The fields described above could be repeated, one set of fields for each product, or each field could have information on multiple products. Furthermore, in addition to having the fields described above the web page 100 could include numerous other unrelated fields which other unrelated information or advertisements.

The method and system apparatus of the present invention have applications on the Internet, as well as in conventional communications systems, such as voice telephony and other communication systems, such as two-way television (a.k.a. interactive television) and WebTVs. Any device that can present information (directly or indirectly through other devices) can be used to present offers. Any device that can accept input from people (directly or indirectly through other devices) can be used to accept indications of interest.

The preferred embodiments of this invention utilize the Internet and standard computer tools used to build high-scale Internet-based services that include financial transactions.

Several companies, including Microsoft Corporation, Netscape Communications, and Oracle, provide commercially available tools and documentation that are frequently used by programmers to implement high-scale web applications. A skilled programmer with access to these tools and documentation could follow the specifications described herein and build a system that utilizes the present invention.

The term “system operator” as used herein does not necessarily refer to an individual. The term refers to an entity or enterprise (which could be an individual) who operates the system controller 13 that accepts orders and makes the previously described calculations. In the embodiment shown in FIG. 1, the system operator 13b server also hosts the web pages that are viewed by potential buyers.

The products offered for sale using the various embodiments of the invention can be products that are offered for sale by the system operator. Alternatively, the system operator can merely provide facility that is used by another to offer products for sale. If it is the system operator that is offering products for sale, when an offer is accepted, the system operator (or an agent of the system operator) will ship the product to the buyer. If the system operator is merely providing a facility for others to offer products for sale, when an offer is accepted, the product will typically be shipped to the buyer by the actual seller (or by an agent for the seller). In such a case, the system operator will only receive a commission for operating the system and the remainder of the purchase price will go the actual seller.

In the embodiments thus far described, the buyers are charged by means of a credit card. Other alternative methods of payment can be used. In yet other embodiments, various other payment mechanisms could be employed.

The term system operator is herein used to refer the person, company or entrepreneur, responsible for the overall operation of the system irrespective of whether or not the system operator owns and operates system controller 13 or if there is some other business relationship between the entrepreneur responsible for the system and the party or entity that owns or operates the actual computer systems and web servers that provide the functions of system controller 13.

It is also noted that in the embodiment shown in FIG. 1, the system controller 13 consists of server hardware running database software, software for performing the logic in FIG. 2, and web server software for hosting one or more websites.

While the present invention has been described in conjunction with embodiments and variations thereof, one of ordinary skill, after reviewing the foregoing specification, will be able to effect various changes, substitutions of equivalents and other alterations without departing from the broad concepts disclosed herein. It is therefore intended that Letters Patent granted hereon be limited only by the definition contained in the appended claims and equivalents thereof.

What is claimed is:

1. A system for bundled selling of goods and services to a plurality of buyers at a prepaid fixed price within a defined time period using the internet, comprising:
a system controller which includes a computer means;
a seller's communication device that communicates with the system controller so that a seller can transmit to the system controller a conditional sales offer for a product or service that specifies a fixed price per unit conditioned upon at least a minimum quantity of units being ordered within a defined time period after which the conditional sales offer expires;
broadcast means for broadcasting the conditional sales offer in communication with the system controller; and
at least one buyer's communication device that communicates with the system controller so that the plurality of buyers respectively transmit to the system controller (a) an acceptance of the conditional sales offer for the sale of the product and (b) make payment of the fixed price via a payment processor, and so that the system controller either (a) executes the sale when at least the minimum quantity of units are ordered within the determined time period or (b) cancels the conditional sales offer and reverses the payment of the fixed price to each of the plurality of individual buyers.

2. The system according to claim 1, wherein the seller communication device is one of (a) a computer terminal so that the seller communicates with the system controller via the Internet, (b) a hard-wired telephone, (c) a mobile telephone, (d) a PDA, (e) an Information Appliance, and (f) a related electronic communication device.

3. The system according to claim 1, wherein the broadcast means for broadcasting the conditional sales offer for the plurality of buyers to hear or view includes at least one of (a) an Internet website in communication with the system controller that includes a web page that displays the conditional sales offer, (b) a radio, (c) a hard-wired telephone, (d) a mobile telephone, (e) a PDA, (f) an Information Appliance, (g) a television, (h) a web TV, (i) an interactive TV, and (j) a related hearing or viewing device.

4. The system according to claim 3, wherein the broadcast means is at least one Internet website through which the plurality of buyers communicates with the system controller via the Internet, and wherein the at least one Internet website does not require respective buyers to register any information as a prerequisite to viewing the web page that displays the conditional sales offer.

5. The system according to claim 4, wherein the Internet website employs a payment processor but does not include any form of Internet Shopping Cart.

6. The system according to claim 1, wherein the at least one buyer communication device includes one or more of (a) a computer terminal which communicates with the system controller either directly or over the Internet via an Internet website or (b) a communication means for communicating with the system controller including one of (1) a hard-wired telephone, (2) a mobile telephone, (3) a PDA, (4) an Information Appliance, (5) a web TV, (6) an interactive TV, and (7) a related communication device.

7. The system according to claim 1, wherein the seller offers an unlimited quantity of units at the fixed price per unit within the defined time period so long as at least the minimum quantity of units is ordered within the defined time period.

8. A method for bundled selling of goods and services to a plurality of buyers at a prepaid fixed price within a defined time period using the Internet, the method comprising the steps of:
a. receiving at a system controller that includes a computer means a conditional sales offer from a seller via a seller's communication device, the conditional sales offer offering a product or service at a fixed price per unit conditioned upon at least a minimum quantity of units being ordered within a defined time period after which the conditional sales offer expires;
b. broadcasting the conditional sales offer to the plurality of individual buyers via broadcasting means which is in communication with the system controller;
c. receiving, via at least one buyer's communication device that communicates with the system controller, transmissions from respective ones of the plurality of buyers indicating (1) an acceptance of the conditional sales offer for the sale of the product and (2) making payment of the fixed price via a payment processor so that the system controller either (1) executes the sale when at least the minimum quantity of units are ordered within the determined time period or (2) cancels the conditional sales offer and reverses the payment of the fixed price to each of the plurality of buyers; and
d. communicating to the plurality of buyers and the seller either (1) that the system controller has executed the sale because at least the minimum quantity of units have been ordered within the determined time period or (2) that the system controller has canceled the conditional sales offer and reversed the payment of the fixed price to each of the plurality of buyers.

9. The method according to claim 8, wherein the seller's communication device is one of (a) a computer terminal so that the seller communicates with the system controller via the Internet, (b) a hard-wired telephone, (c) a mobile telephone, (d) a PDA, (e) an Information Appliance, and (f) a related electronic communication device.

10. The method according to claim 8, wherein the broadcast means for broadcasting the conditional sales offer for the plurality of buyers to hear or view includes at least one of (a) an Internet website in communication with the system controller that includes a web page that displays the conditional sales offer, (b) a radio, (c) a hard-wired telephone, (d) a mobile telephone, (e) a PDA, (f) an Information Appliance, (g) a television, (h) a web TV, (i) an interactive TV, and (j) a related hearing or viewing device.

11. The method according to claim 10, wherein the broadcast means is at least one Internet website through which the plurality of buyers communicates with the system controller via the Internet, and wherein the at least one Internet website does not require respective buyers to register any information as a prerequisite to viewing the web page that displays the conditional sales offer.

12. The method according to claim 11, wherein the Internet website employs the payment processor but does not include any form of Internet Shopping Cart.

13. The method according to claim 8, wherein the at least one buyer communication device includes one or more of (a) a computer terminal which communicates with the system controller either directly or over the Internet via an Internet website or (b) a communication means for communicating with the system controller including one of (1) a hard-wired telephone, (2) a mobile telephone, (3) a PDA, (4) an Information Appliance, (5) a web TV, (6) an interactive TV, and (7) a related communication device.

14. The method according to claim 8, wherein the seller offers an unlimited quantity of units at the fixed price per unit within the defined time period so long as at least the minimum quantity of units is ordered within the defined time period.

15. The method according to claim 8, wherein a system operator provides the system controller for communicating conditional sales offers from the seller to the plurality of buyers.

16. The method according to claim 15, wherein the system operator receives a commission on the fixed price paid by the plurality of buyers to the seller.

17. The method according to claim 15, wherein the conditional sales offer is broadcast by being displayed on at least one website operated by a respective website operator, and wherein the system operator and each respective website operator receive a commission on the fixed price paid by the plurality of buyers to the seller.

18. The method according to claim 8, wherein the payment processor collects a credit card number from respective buyers, obtains a pre-authorization of the payment from respective credit card issuers, and either (a) manually processes the payment when the sale is executed or (b) reverses the payment by failing to manually process the payment when the sale is cancelled.

19. The method according to claim 8, further comprising requesting that respective buyers promote the product or service to others within their respective social networks to facilitate reaching the minimum quantity of units.

20. The method according to claim 8, wherein the system controller executes the sale by placing one simultaneous order with at least one of the seller and a supplier so that a cost effective simultaneous shipment to respective buyers takes place.
